(19) United States
(12) Patent Application Publication
(10) Pub. No.: US 2025/0374387 A1
(43) Pub. Date: Dec. 4, 2025

(54) COOKING APPLIANCE

(71) Applicant: LG Electronics Inc., Seoul (KR)

(72) Inventors: Dong Hun KIM, Seoul (KR); Young Jin KIM, Seoul (KR); Jeongkil KIM, Seoul (KR); Junhwan JANG, Seoul (KR); Geon KWON, Seoul (KR); Hansu LEE, Seoul (KR)

(73) Assignee: LG Electronics Inc., Seoul (KR)

(21) Appl. No.: 19/212,401

(22) Filed: May 19, 2025

(30) Foreign Application Priority Data
May 30, 2024 (KR) 10-2024-0070856
Dec. 16, 2024 (KR) 10-2024-0187154

(51) Int. Cl. H05B 6/64; F24C 15/02; H04R 1/02; H04R 1/40

(52) U.S. Cl. CPC H05B 6/6435; H04R 1/028; H04R 1/406; F24C 15/02

(57) ABSTRACT

A cooking appliance including a main body with a cavity defined therein, and a door that opens and closes the cavity. The door includes an outer panel where a display is mounted, and a microphone module disposed at a lower portion of the outer panel and positioned at an edge spaced apart from a center of the outer panel in a lateral direction.

### CROSS-REFERENCE TO RELATED APPLICATION

This application claims priority to and benefit of Korean Patent Application No. 10-2024-0070856, filed on May 30, 2024, and Korean Patent Application No. 10-2024-0187154, filed on Dec. 16, 2024, all of which are hereby expressly incorporated by reference as if fully set forth herein.

### BACKGROUND

### Field

The present disclosure relates to a cooking appliance, and more particularly, to a cooking appliance installed above a heating cooking apparatus.

### Description of Related Art

Content described in this section merely provides background information on the present disclosure and does not constitute the prior art.

A cooking appliance is a home appliance that cooks food using a microwave, which is a type of an electromagnetic wave, and/or heater heat. The cooking appliance may be generally composed of a cavity, which is a space in which the food is placed and cooked, and a door that opens and closes the cavity.

When the cooking appliance is installed indoors, it is necessary to consider efficient use of the cooking appliance, saving of an installation space, and the like.

For this reason, the cooking appliance may be disposed at a location adjacent to a heating cooking appliance, for example, a heating oven, a gas stove, and the like. Specifically, the cooking appliance may be disposed above the heating cooking apparatus.

When the cooking appliance is disposed above the heating cooking apparatus, a user may conveniently cook the food by reducing a movement in an environment in which the cooking appliance and the heating cooking apparatus are adjacent to each other. In addition, heat, oil vapor, and the like generated from the heating cooking apparatus may be discharged to the outside using the cooking apparatus as a hood.

For example, a display may be mounted on a front surface of the door equipped in the cooking appliance to provide various information to the user. The user may identify a cooked state of the food via the display.

In addition, when the display is connected to another home appliance to serve as a hub of the home appliance, information other than the cooking of the food may be obtained via the display. In addition, a command necessary for the cooking and various other commands may be input to the display by a touch method.

### SUMMARY

A purpose of the present disclosure is to provide a cooking appliance including a microphone module that recognizes a user's voice.

Further, a purpose of the present disclosure is to provide a cooking appliance having a structure capable of protecting a microphone module from foreign substances such as oil vapor.

Further, a purpose of the present disclosure is to provide a cooking appliance including a door having a structure in which a microphone module is stably mounted.

Purposes according to the present disclosure are not limited to the above-mentioned purpose. Other purposes and advantages according to the present disclosure that are not mentioned may be understood based on following descriptions, and may be more clearly understood based on embodiments according to the present disclosure. Further, it will be easily understood that the purposes and advantages according to the present disclosure may be realized using means shown in the claims or combinations thereof.

An embodiment of the cooking appliance may include a main body with a cavity defined therein, and a door that opens and closes the cavity.

The door may include an outer panel where a display is mounted. The door may include a microphone module disposed at a lower portion of the outer panel and positioned at a location spaced apart from a center of the outer panel in a lateral direction. The microphone module may be disposed at an edge of the outer panel.

Accordingly, a large portion of foreign substances generated and rising from a heating cooking apparatus disposed below the cooking appliance may be adhered to a central portion of a bottom surface of the outer panel, and a relatively small amount of the foreign substances may reach the microphone module disposed at the edge of the outer panel.

The microphone module may include a microphone that receives a user's voice. The microphone module may include a mounting substrate where the microphone is mounted. The microphone module may include a low supporter where the microphone and the mounting substrate are disposed. The microphone module may include an upper supporter constructed to support one surface of the mounting substrate and accommodate portions of the microphone and the mounting substrate together with the low supporter.

The low supporter may include a protrusion accommodating portion having a bottom surface protruding downward and a top surface defining a space where the mounting substrate and the microphone are accommodated. The low supporter may include a first coupling rib protruding upward from the bottom surface of the protrusion accommodating portion. The first coupling rib may be coupled with the upper supporter, and have a first fastening hole defined therein, where a coupling mechanism is fastened. The low supporter may include a second coupling rib protruding upward from an edge of the protrusion accommodating portion and coupled with the outer panel. The second coupling rib may have a second fastening hole defined therein, where a coupling mechanism is fastened.

The protrusion accommodating portion may include an inclined portion where the microphone is disposed to be inclined at a predetermined angle with respect to a vertical direction. The protrusion accommodating portion may include an exposure hole that is constructed to expose a portion of an interior of the microphone module to the outside. The protrusion accommodating portion may be defined to extend through the inclined portion.

The low supporter may include a first suppression protrusion formed at a location corresponding to the exposure hole, wherein the first suppression protrusion is formed to extend further at a lower portion than at an upper portion to suppress foreign substances in a vapor state from flowing into the exposure hole. The low supporter may include a second suppression protrusion protruding downward from an upper end of the inclined portion to suppress the foreign substances in the vapor state from flowing into the exposure hole.

The first suppression protrusion or the second suppression protrusion disposed on the lower supporter may effectively block the foreign substances from flowing into the exposure hole.

In the cooking appliance according to the present disclosure, the microphone module may be disposed at the lower portion of the outer panel, and may be disposed at the edge spaced apart from the center of the outer panel in the lateral direction.

By disposing the microphone module at such a location, the large portion of the foreign substances generated and rising from the heating cooking apparatus located below the cooking appliance may be adhered to the central portion of the bottom surface of the outer panel. Accordingly, the relatively small amount of the foreign substances may reach the microphone module disposed at the edge of the outer panel. Therefore, the amount of foreign substances introduced into the microphone module may be reduced, thereby effectively suppressing the failure and the performance degradation of the microphone module.

In addition, in the cooking appliance according to the present disclosure, the first suppression protrusion and the second suppression protrusion disposed on the lower supporter may effectively block the foreign substances from being introduced into the exposure hole. Accordingly, the foreign substances may be blocked from being introduced into the exposure hole, and the electrical components such as the microphone and the mounting substrate inside the microphone module may be effectively protected.

In addition, accordingly, the clogging of the exposure hole by the foreign substances may be effectively suppressed, thereby effectively suppressing the deterioration of the voice recognition performance of the microphone.

In addition to the above-described effects, specific effects of the present disclosure will be described together while describing specific matters for implementing the present disclosure.

### BRIEF DESCRIPTION OF DRA WINGS

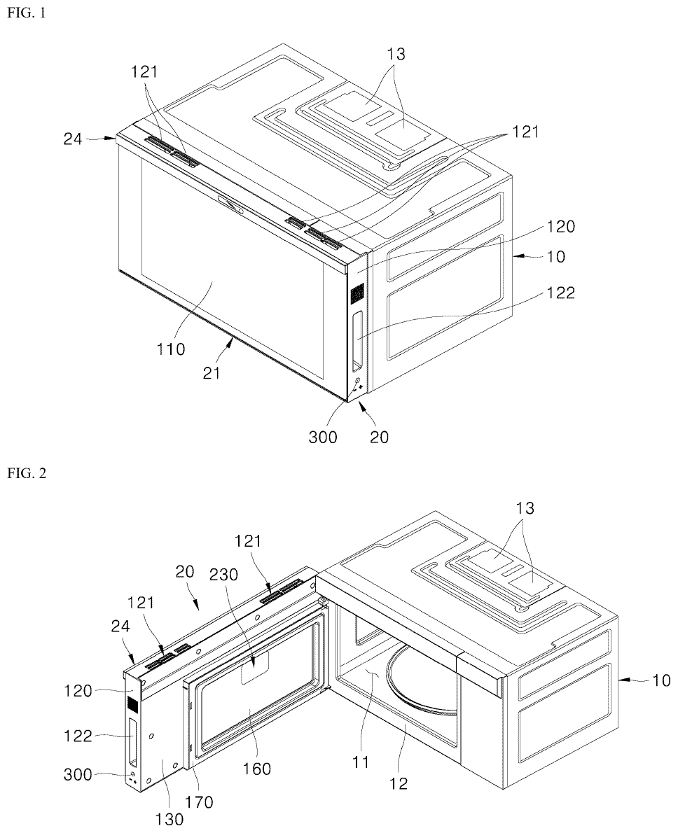

FIG. 1 is a perspective view illustrating a cooking appliance according to an embodiment.

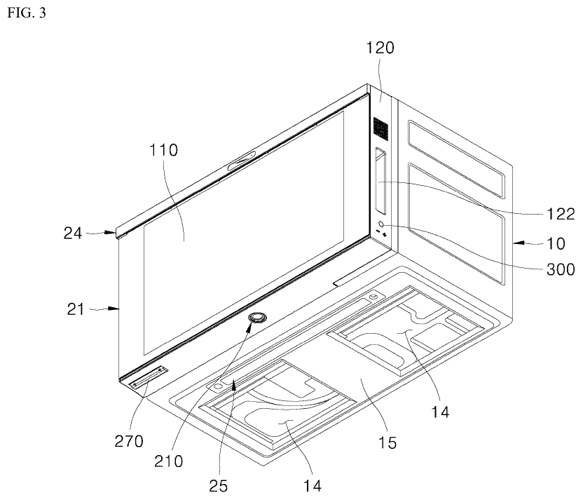

FIG. 2 is a view illustrating a state in which a door is opened in FIG. 1.

FIG. 3 is a view of FIG. 1 in another direction.

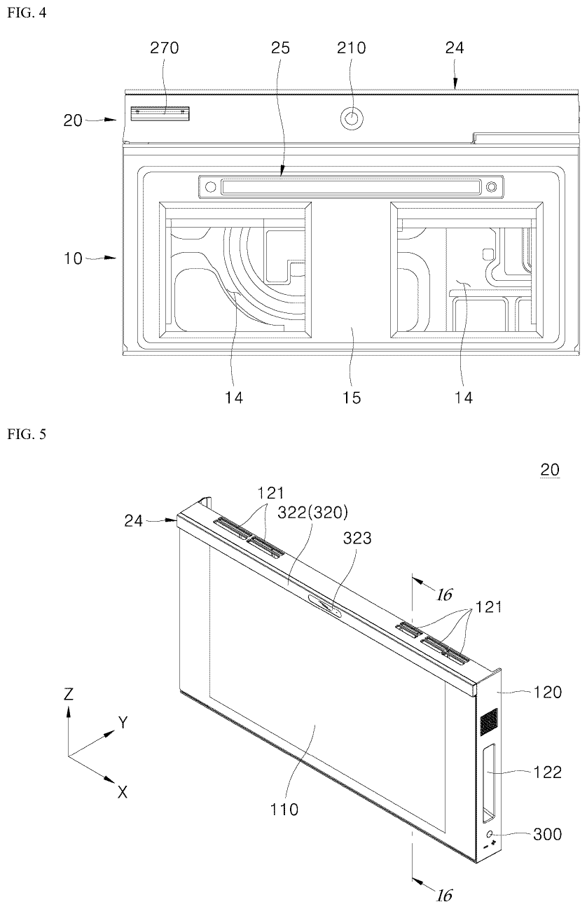

FIG. 4 is a bottom view of a cooking appliance according to an embodiment.

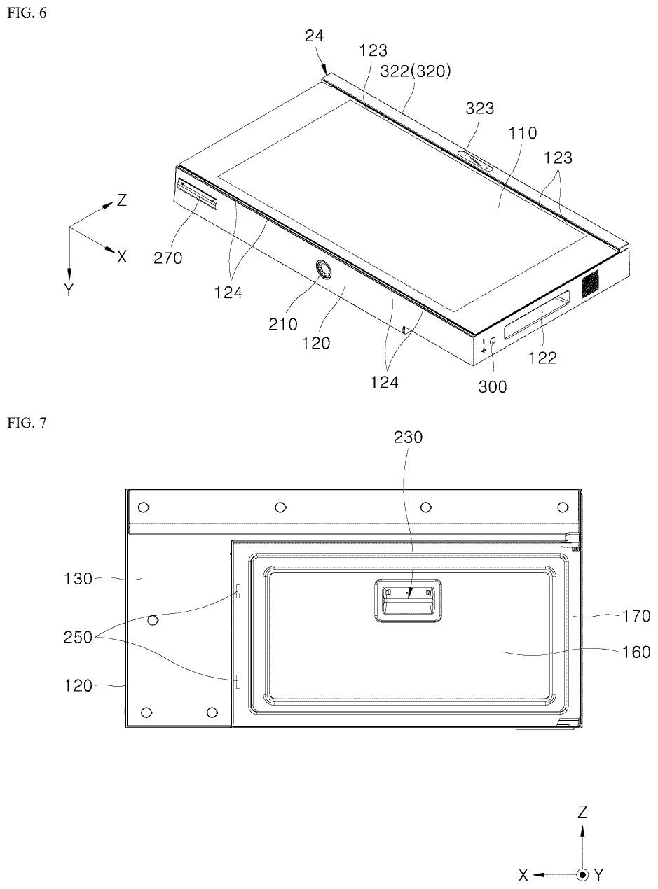

FIG. 5 is a perspective view illustrating a door of a cooking appliance according to an embodiment.

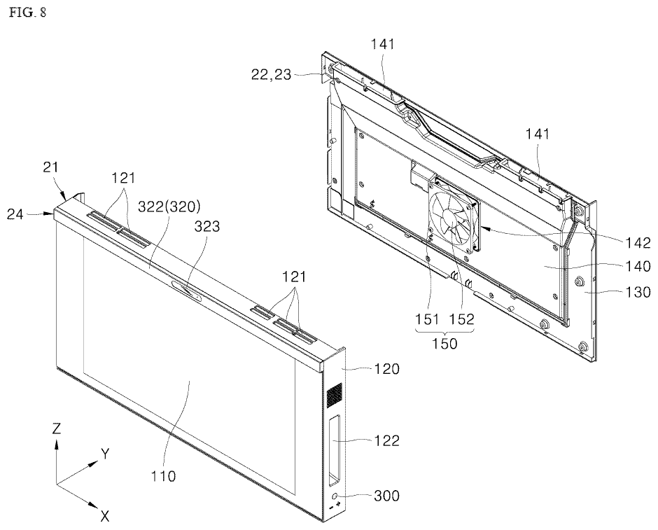

FIG. 6 is a view of FIG. 5 in another direction.

FIG. 7 is a rear view of a door.

FIG. 8 is an exploded perspective view of a portion of a door according to an embodiment.

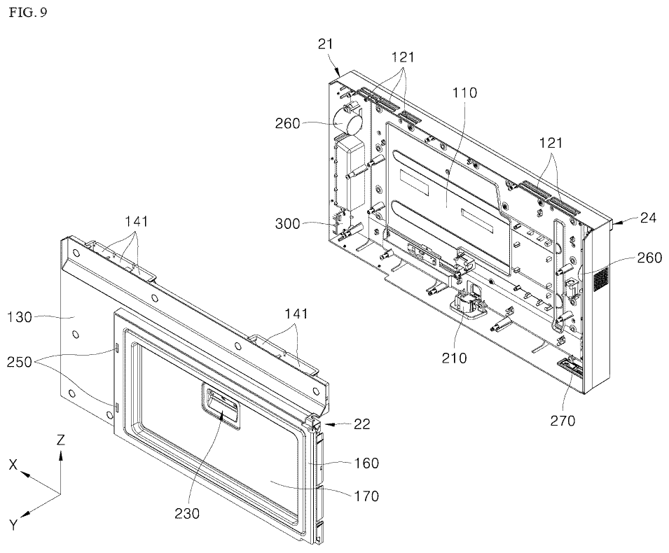

FIG. 9 is a view of FIG. 8 in another direction.

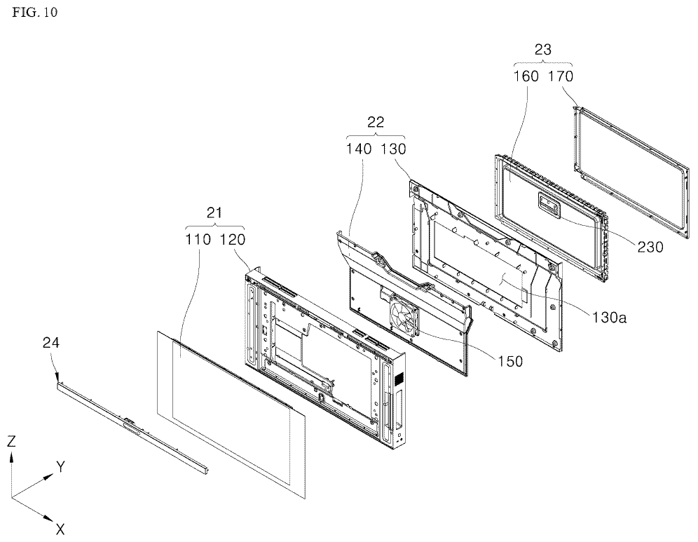

FIG. 10 is an exploded perspective view of a door according to an embodiment.

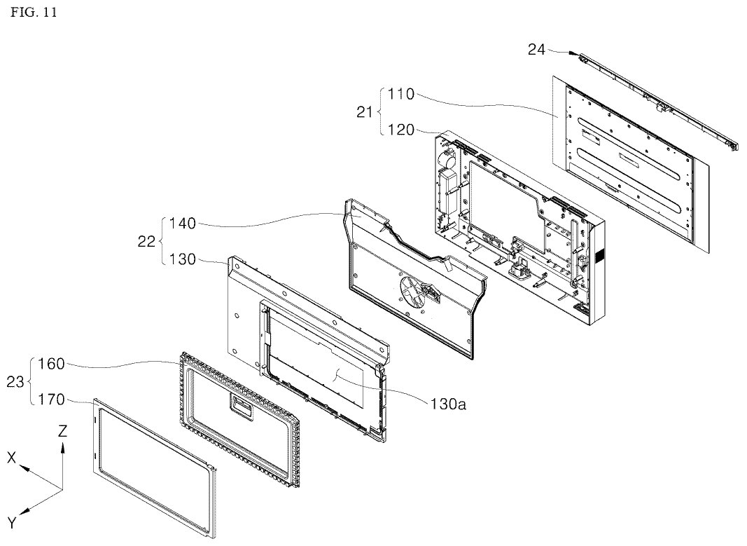

FIG. 11 is a view of FIG. 10 in another direction.

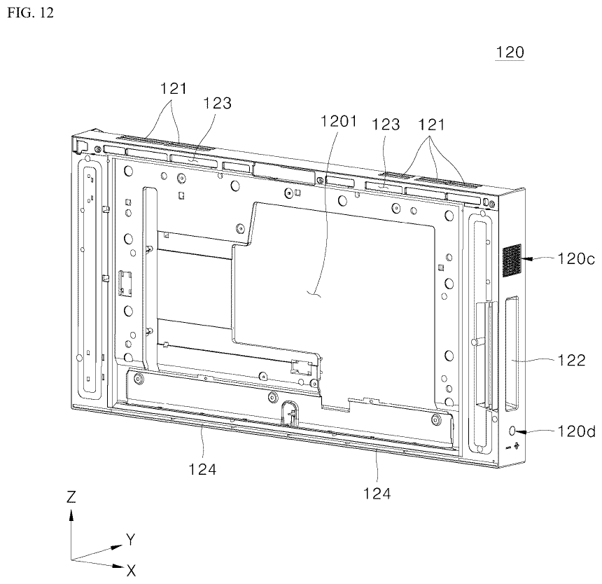

FIG. 12 is a perspective view illustrating an outer panel according to an embodiment.

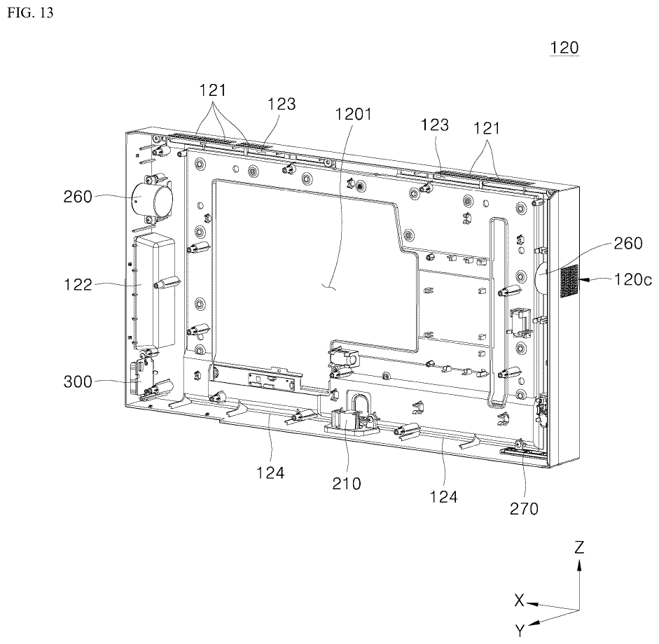

FIG. 13 is a view of FIG. 12 in another direction.

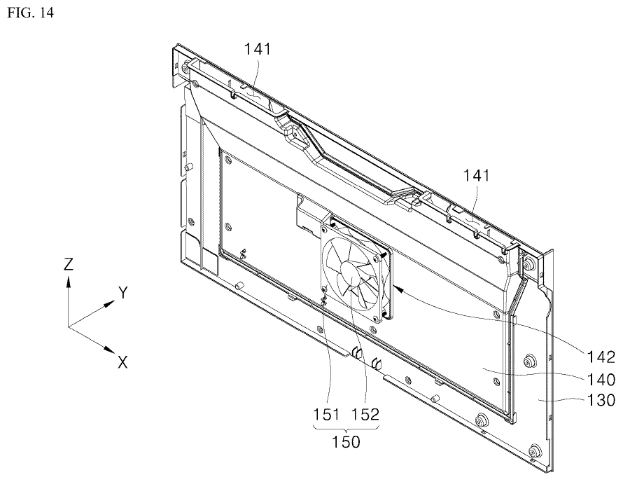

FIG. 14 is a view illustrating an inner panel and an air guide according to an embodiment.

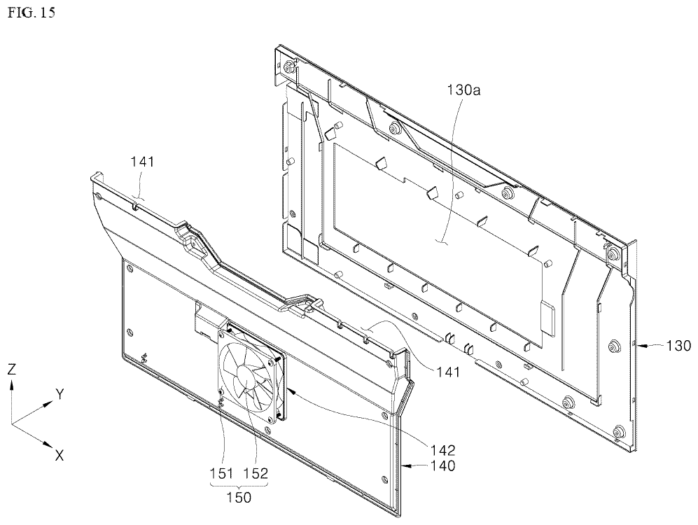

FIG. 15 is an exploded perspective view of FIG. 14.

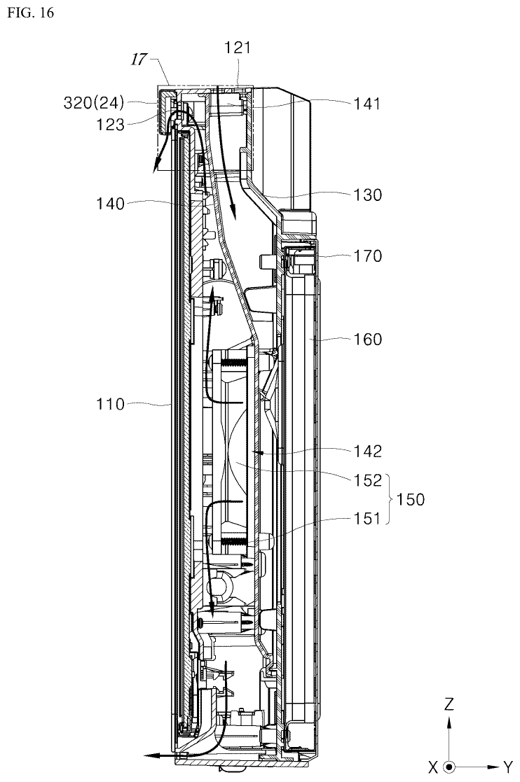

FIG. 16 is a side cross-sectional view of a door viewed in a direction 16-16 in FIG. 5.

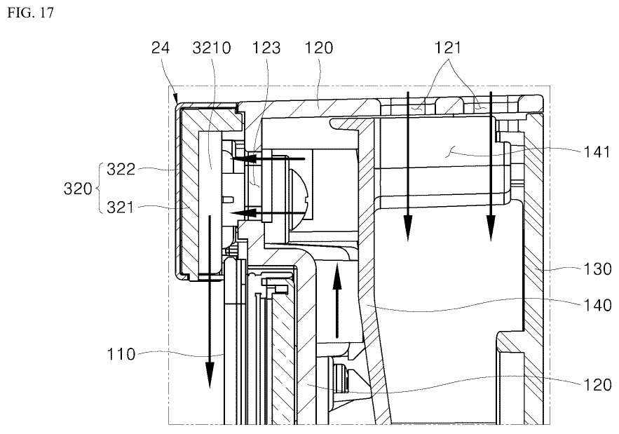

FIG. 17 is an enlarged view of a portion 17 in FIG. 16.

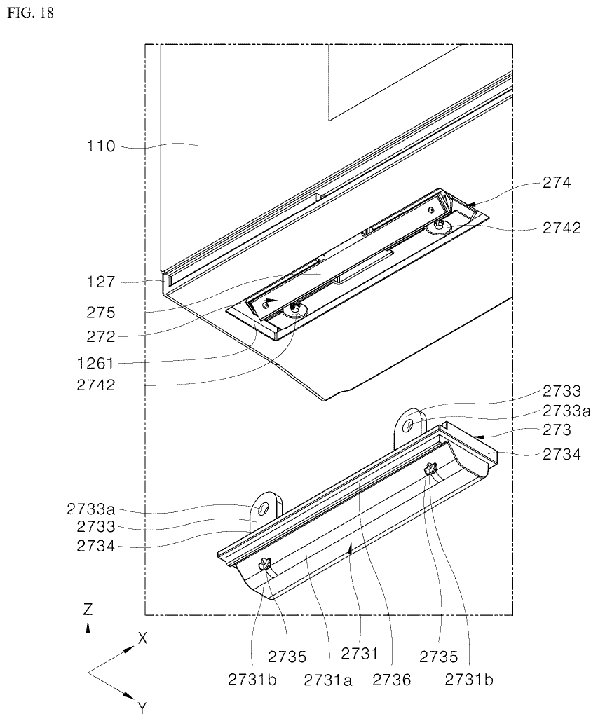

FIG. 18 is a perspective view in which some parts of a microphone module according to an embodiment are removed from a door.

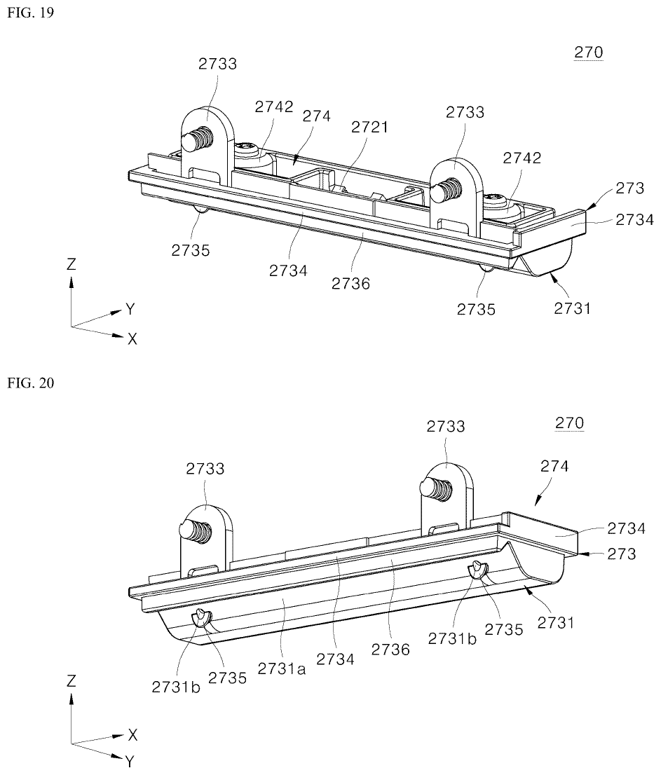

FIG. 19 is a perspective view of a microphone module according to an embodiment.

FIG. 20 is a view of FIG. 19 in another direction.

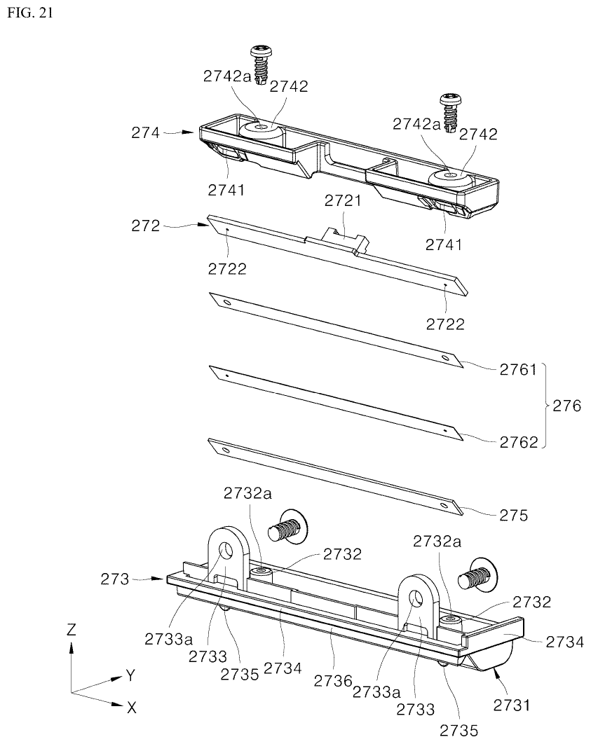

FIG. 21 is an exploded perspective view of a microphone module according to an embodiment.

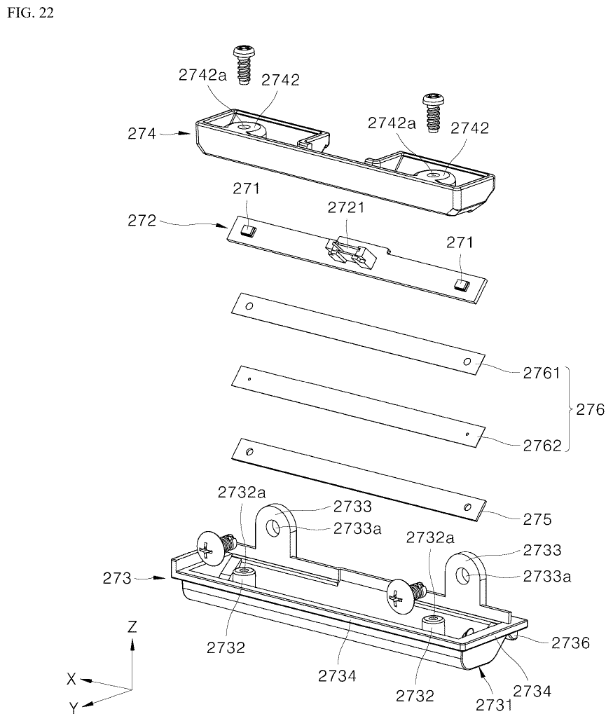

FIG. 22 is a view of FIG. 21 in another direction.

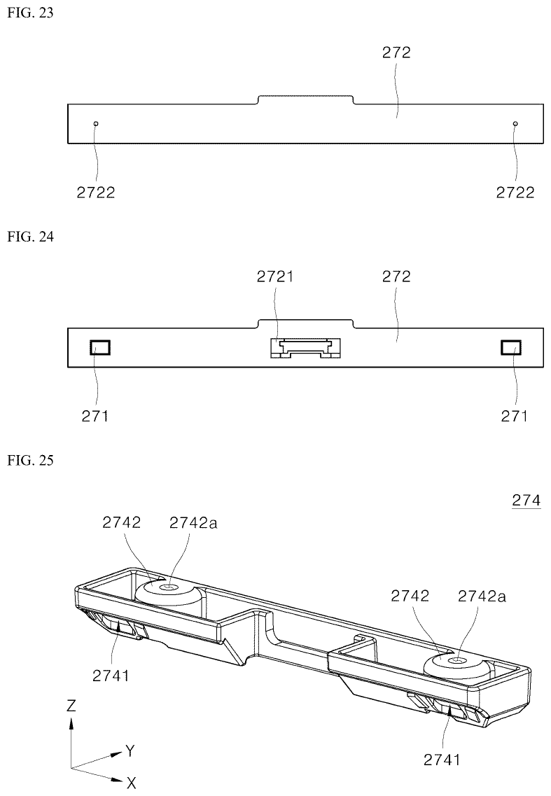

FIG. 23 is a front view of a mounting substrate according to an embodiment.

FIG. 24 is a rear view of a mounting substrate according to an embodiment.

FIG. 25 is a perspective view of an upper supporter according to an embodiment.

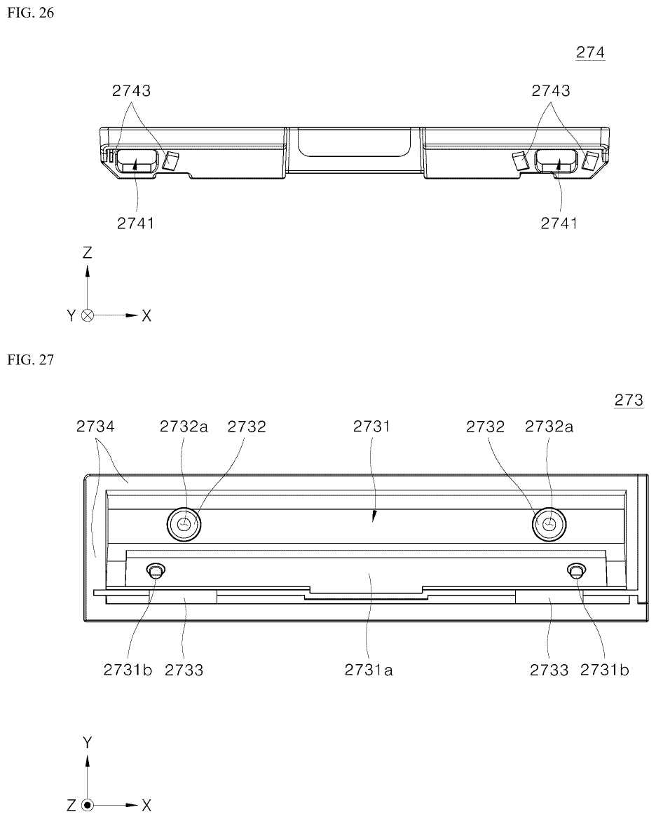

FIG. 26 is a front view of an upper supporter according to an embodiment.

FIG. 27 is a plan view of a low supporter according to an embodiment.

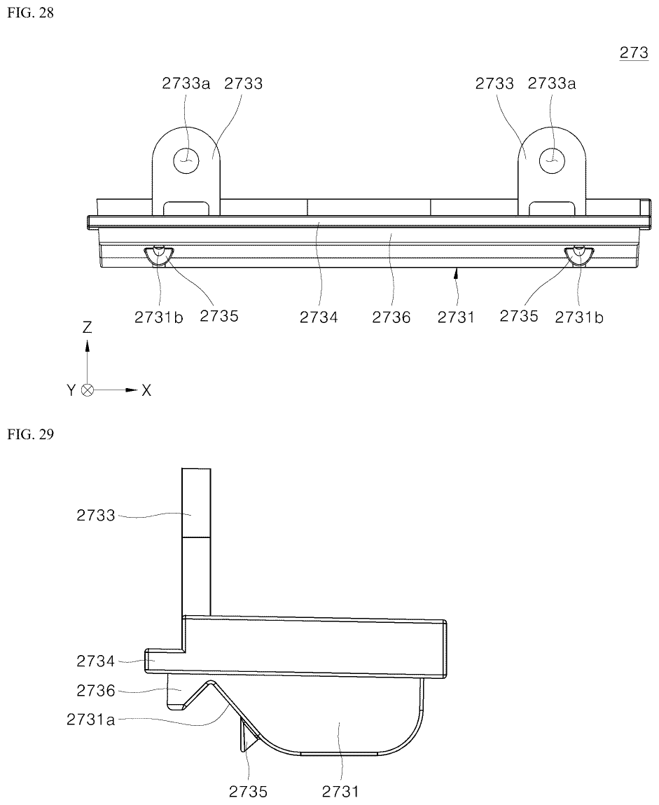

FIG. 28 is a front view of a low supporter according to an embodiment.

FIG. 29 is a side view of a low supporter according to an embodiment.

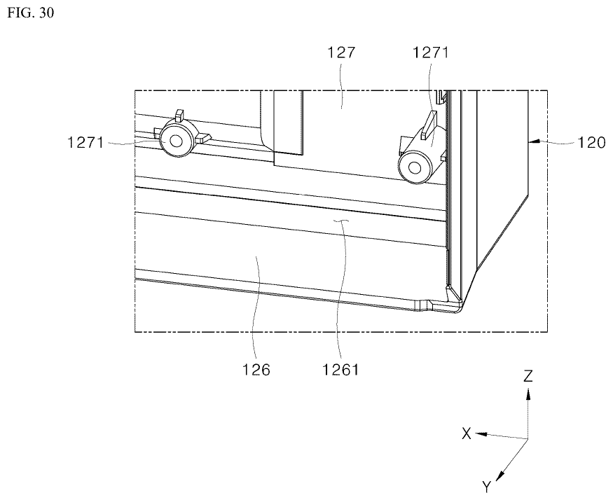

FIG. 30 is a view illustrating a first coupling protrusion disposed on an outer panel.

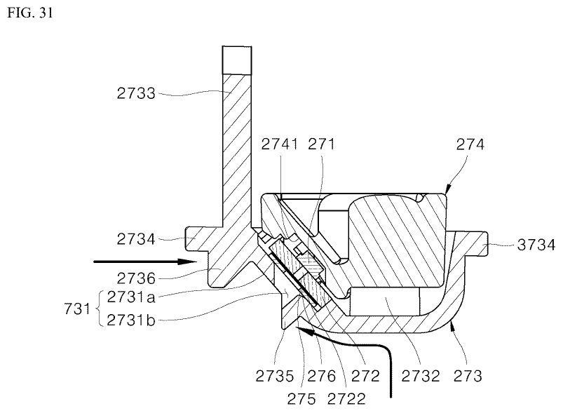

FIG. 31 is a cross-sectional view of a microphone module, in which a microphone is cut.

### DETAILED DESCRIPTIONS

The above-mentioned purposes, features, and advantages will be described in detail later with reference to the attached drawings, so that those skilled in the art in the technical field to which the present disclosure belongs may easily practice the technical ideas of the present disclosure. In describing the present disclosure, when it is determined that a detailed description of the publicly known technology related to the present disclosure may unnecessarily obscure the gist of the present disclosure, the detailed description thereof will be omitted. Hereinafter, a preferred embodiment according to the present disclosure will be described in detail with reference to the attached drawings. In the drawings, identical reference numerals are used to indicate identical or similar components.

Although first, second, and the like are used to describe various components, these components are not limited by such terms. Such terms are only used to distinguish one component from another component, and unless specifically stated to the contrary, a first component may also be a second component.

Throughout the present document, unless otherwise stated, each component may be singular or plural.

As used herein, singular expressions include plural expressions, unless the context clearly dictates otherwise. In the present application, terms such as “composed of” or “include” should not be construed as necessarily including all of various components or steps described herein, and should be interpreted as being able to not including some of the components or the steps and further including additional components or steps.

Throughout the present disclosure, “A and/or B” means A, B, or A and B, unless otherwise specified, and “C to D” means C inclusive to D inclusive unless otherwise specified.

Throughout the present document, a “vertical direction” refers to a vertical direction of a cooking appliance in a state in which the cooking appliance is installed to be used on a daily basis. A “left and right direction” means a direction orthogonal to the vertical direction, and a front and rear direction means a direction orthogonal to both the vertical direction and the left and right direction. A “lateral direction” has the same meaning as the left and right direction, and such terms are able to be used interchangeably herein.

FIG. 1 is a perspective view illustrating a cooking appliance according to an embodiment. FIG. 2 is a view illustrating a state in which a door 20 is opened in FIG. 1.

The cooking appliance according to an embodiment may be disposed above a location where a heating cooking appliance, for example, a heating oven, a gas stove, and the like, is disposed, at a location spaced apart from the heating cooking appliance in the vertical direction.

Because of such an arrangement of the cooking appliance, a user may conveniently use cooking apparatuses including the cooking appliance. In addition, the cooking appliance may serve as a hood of the heating cooking apparatus disposed below. In this case, the cooking appliance may include components for the use as the hood.

The cooking appliance may cook food using a microwave, which is a type of an electromagnetic wave, and/or heater heat. The cooking appliance may include a main body 10 in which the cavity 11 is formed, and a door 20 that opens and closes the cavity 11.

The food to be cooked may be placed in the cavity 11. The door 20 may be disposed in front of the cavity 11 and pivotably mounted on the main body 10 to open and close the cavity 11.

The cooking appliance may serve as the hood for discharging gaseous foreign substances discharged from the heating cooking apparatus disposed below to the outside. To this end, a vent hole 13 for discharging moisture, oil vapor, and the like generated in the heating cooking appliance disposed below the cooking appliance to the outside may be defined at an upper portion of the main body 10.

The main body 10 may further include a front panel 12 that is disposed at an edge of an entrance of the cavity 11, and closes the cavity 11 by being disposed such that one surface thereof faces one surface of a choke member 170 when the door 20 is closed.

The front panel 12 may be disposed to surround the entrance edge of the cavity 11 and protrude with a predetermined width. Accordingly, when the door 20 is closed, an edge of the door 20 and the cavity 11 may overlap each other.

Because of such a structure, the front panel 12 may seal the cavity 11 in the state in which the door 20 is closed, thereby suppressing oil, moisture, oil vapor, and the like generated during a cooking process of the food placed in the cavity 11 from being leaked to the outside via the entrance of the cavity 11.

FIG. 3 is a view of FIG. 1 in another direction. FIG. 4 is a bottom view of a cooking appliance according to an embodiment.

A suction unit 14 for sucking moisture, oil vapor, and the like rising from the heating cooking appliance may be disposed at a lower portion of the main body 10. Accordingly, the cooking appliance may serve as the hood that sucks air discharged from the heating cooking appliance disposed below the cooking appliance and discharges the air to the outside.

The suction unit 14 and the vent hole 13 may be defined to be in communication with each other, and thus, gas such as oil vapor introduced into the suction unit 14 may be discharged to the outside via the vent hole 13, and the vent hole 13 may be in communication with a duct connected to the outside.

In one example, the cavity 11 of the cooking appliance is formed not to be in communication with the suction unit 14 and the vent hole 13, so that gas such as oil vapor introduced from the suction unit 14 may be discharged to the outside of the main body 10 directly via the vent hole 13 without being introduced into the cavity 11.

A bottom panel 15 may be disposed at the lower portion of the main body 10, and the suction unit 14 may be formed to extend through the bottom panel 15 and be in communication with the vent hole 13.

The bottom panel 15 may include a lighting unit 25 that irradiates light in a downward direction. Such a lighting unit may be formed, for example, in a shape long in the lateral direction of the cooking appliance. By the light irradiated from the lighting unit 25, the user may conveniently use the heating cooking appliance disposed below the cooking appliance.

FIG. 5 is a perspective view illustrating the door 20 of the cooking appliance according to an embodiment. FIG. 6 is a view of FIG. 5 in another direction.

FIG. 7 is a rear view of the door 20. FIG. 8 is an exploded perspective view of a portion of the door 20 according to an embodiment. FIG. 9 is a view of FIG. 8 in another direction.

The door 20 may include a display module 21, a cooling flow path 22, and a shielding portion 23. The display module 21 may be disposed at a front portion of the door 20, and the user may view inside of the cavity 11 of the cooking appliance through the display module 21.

The cooling flow path 22 may be disposed at the rear of the display module 21, and a flow path through which air for cooling flows may be formed therein. Air introduced into the door 20 may flow inside the door 20 via the cooling flow path 22 to cool the door 20.

The shielding portion 23 may be disposed at the rear of the cooling flow path 22, and may shield the electromagnetic wave generated in the main body 10. The shielding portion 23 may protect the user by blocking the electromagnetic wave generated in the cavity 11 and propagated to the outside of the cooking appliance.

For example, the shielding portion 23 may serve to block the electromagnetic wave (the microwave) generated to cook the food in the main body 10 from being discharged to the outside of the door 20.

The cooling flow path 22 may be disposed to cool electronic components mounted inside the door 20, including a display 110 mounted on the display module 21. In the cooling flow path, air that cools the door 20 may flow inside. The display 110 may be formed in a thin shape and may be disposed such that an area thereof occupies a significant portion of one surface of the door 20.

Accordingly, the display 110 is formed to occupy a significant portion of a front surface area of the door 20, and the area of the display 110 is increased, so that visibility to the user may be improved. The user may conveniently check the various information via the display 110 formed as a large screen.

Because the display 110 is enlarged, an amount of heat generated may increase. Therefore, the display 110 needs to be effectively cooled on the door 20. In an embodiment, the cooling flow path through which cooling air flows may be separately disposed.

The cooling flow path 22 may be disposed at the rear of the display 110, so that cooling air may flow, and thus the display module 20 may be effectively cooled by air flowing through the cooling flow path 22. In addition, heating components mounted in the display module 21 may also be cooled by air flowing through the cooling flow path 22. That is, the cooling flow path 22 may cool the display module 21 equipped with the display 110 and various other heating components.

To effectively cool the display 110, an entirety of the display 110 needs to be exposed to air flowing through the cooling flow path 22. In addition, the air flow passing through the cooling flow path 22 and discharged to the outside of the door 20 needs to form an air curtain to block heat and oil vapor rising from the heating cooking appliance disposed below the cooking appliance.

To this end, air flowing through the cooling flow path 22 may be branched from the inside of the cooling flow path 22 so as to be discharged upward and downward of the display module 21.

As cooling air is branched from the inside of the cooling flow path 22 and discharged upward and downward of the display module 21, cooling air may flow while coming into contact with an entirety of a rear surface of the display 110 to effectively cool the display 110.

In addition, as cooling air is discharged upward and downward of the display module 21, the air curtain is effectively formed around the display and the door 20, so that heat and oil vapor rising from the heating cooking appliance disposed below the cooking appliance may be effectively blocked by the air curtain.

The display module 21 may be equipped with the display 110, a camera, and other electronic components, and the cooling flow path 22 may be equipped with electronic components such as a blower 150 operated by a motor. Accordingly, to protect the user and the electronic components from the electromagnetic wave, the shielding portion 23 that shields the electromagnetic wave generated in the main body may be disposed at the rear of the cooling flow path 22.

In the display module 21, the display 110 and various electronic components may be disposed. Further, the cooling flow path 22 in which a flow path of air that cools the display module 21 is formed may be disposed at the rear of the display module 21, and the shielding portion 23 that shields the electromagnetic wave from reaching the electronic components equipped in the display module 21 may be disposed at the rear of the cooling flow path 22.

In an embodiment, the display module 21 for providing the various information and convenience to the user needs to be disposed on a front surface of the cooking appliance, that is, at a forefront of the door 20. In addition, in an embodiment, a structure is required to effectively cool the components such as the display 110 equipped in the display module 21, to form the flow path of cooling air for forming the air curtain around the door 20 while effectively cooling the inside of the door 20 equipped with the display 110 and the like, and to protect the electronic components mounted in the door 20 from the electromagnetic wave.

To meet such a need, the display module 21 may be disposed at the foremost of the door 20. the cooling flow path 22 may be disposed at the rear of the display module 21, and the shielding portion 23 may be disposed at the rear of the cooling flow path 22.

That is, to implement the door structure according to the above-described embodiment, the display module 21, the cooling flow path 22, and the shielding portion 23, which play respective roles in the door 20, need to be sequentially arranged from a front side to a rear side of the door 20.

The display module 21 may include a first outlet 123 and a second outlet 124. The first outlet 123 may be disposed at an upper portion of the display module 21, and air flowing inside the display module 21 may be discharged to the outside via the first outlet 123.

The second outlet 124 may be disposed at a lower portion of the display module 21, and air flowing inside the display module 21 may be discharged to the outside via the second outlet 124. That is, air flowing inside the door 20 may be discharged to the outside via the first outlet 123 and the second outlet 124 respectively disposed at the upper and lower portions of the door 20, and accordingly, air may flow through the entire inside of the door 20 to effectively cool the entire door 20.

The display module 21 may include the display 110 and an outer panel 120. The display 110 may be disposed on the front surface of the door 20 to display a video or an image.

The display 110 may display information necessary for the cooking and provide the information to the user. In addition, the display 110 may receive a user's command in a touch recognition method.

In one example, the display 110 may be communicatively connected to other home appliances, a camera disposed at a main door, a locking device, and the like. In addition, the display 110 may be communicatively connected to an external device required by the user.

The user may receive information necessary for operation of the home appliance, visit of an outsider, and other life from the display 110, and transmit commands to the home appliance and other devices connected to the display 110 using the display 110.

Accordingly, the door 20 including the display 110 may serve as a kind of an IoT hub that transmits the information regarding the home appliance and other devices necessary for living to the user and transmits user's commands to such devices.

The outer panel 120 may be disposed at the rear of the display 110, and the display 110 may be mounted thereon. The outer panel 120 may generally have a hollow 1201 and may be formed in a shape having a predetermined width in a front and rear direction of the door 20. The outer panel 120 may form an overall outer appearance of the door 20.

The hollow 1201 of the outer panel 120 may be closed by a rear surface of the display 110. Air flowing inside the outer panel 120 may hit the rear surface of the display 110 exposed through the hollow 1201 of the outer panel 120. Accordingly, air flowing inside the outer panel 120 may come into contact with the rear surface of the display 110 and cool the display 110.

In addition, air passing through a blower fan 152 may cool the heating components such as a speaker 260, a microphone 271, a printed circuit board, and the like, which are disposed to be exposed through the hollow 1201 of the outer panel 120.

Because the outer panel 120 has the above-described structure, it may have a built-in space, and various components may be built in the built-in space. A width of the door 20 in the front and rear direction may be determined almost by the outer panel 120.

A first vent hole 121 through which air is introduced may be defined in an upper end of the outer panel 120. A plurality of first vent holes 121 may be defined. Each of the first vent holes 121 may be defined such that a plurality of slit-shaped holes are arranged at a distance. Because of such a structure, the external foreign substances may be somewhat suppressed from being introduced into the door 20 via the first vent hole 121.

A handle 122 may be formed at one side of the outer panel 120 to be used when the user opens and closes the door 20. The handle 122 may be defined, for example, by recessing the side of the outer panel 120.

A button device 300 may be mounted on one side of the outer panel 120, for example, directly below a location where the handle 122 is formed. The user may manipulate the button device 300 to supply electricity to the cooking appliance or cut off the supply of electricity. Detailed manipulation related to the operation of the cooking appliance may be performed by inputting a command to the display 110.

The outer panel 120 may support the various components such as the display 110, the speaker 260, the microphone module 270, and the printed circuit board for communication or control, and may include the first vent hole 121 through which external air is introduced, and the first outlet 123 and the second outlet 124 through which air is discharged.

In one example, the door 20 may be equipped with the camera. The image filmed by the camera may be reproduced on the display 110, and the user may view an image of an inside of the cavity 11 or a space under the cooking appliance via the display 110. The camera may include a first camera 310, a second camera 210, and a third camera 230.

The first camera 310 may be disposed at an upper front portion of the display module 21 to film a space ahead of the cooking appliance.

The first camera 310 may film the user in front of the cooking appliance or an indoor space. Accordingly, the first camera 310 may be used for the user to make a video call with another person outside the main door or at another remote place using the display 110. The first camera 310 will be described in detail below.

The second camera 210 may be mounted at a lower portion of the outer panel 120 to film a state of a space under the door 20. Because the second camera 210 is mounted at the lower portion of the outer panel 120 such that a line of sight is directed to the space under the cooking appliance, it may film the heating cooking apparatus disposed below the cooking appliance. Alternatively, the second camera 210 may be utilized to monitor a state of the heating cooking appliance below the cooking appliance.

The user may observe the state of the heating cooking appliance and a cooked state of food on the heating cooking appliance by the image filmed by the second camera 210 and reproduced on the display 110.

The third camera 230 may be mounted on the frame 160, may be disposed to face the cavity 11, and may film the cavity 11. That is, a line of sight of the third camera 230 may be directed toward the cavity 11 to film a situation of the cavity 11. The user may observe a situation in which the food is cooked in the cavity 11 via the image filmed by the third camera 230.

The door 20 may include a latch 250 mounted at a side of the frame 160 and formed to partially protrude from the frame 160. The latch 250 may be formed in a structure that is hooked to a groove defined in the front panel 12 of the door 20. The latch 250 may stably maintain the closed state of the door 20.

FIG. 10 is an exploded perspective view of the door 20 according to an embodiment. FIG. 11 is a view of FIG. 10 in another direction. The cooling flow path 22 may include an inner panel 130, an air guide 140, and the blower 150.

The inner panel 130 may be disposed at the rear of the outer panel 120 and may be mounted on the outer panel 120. The air guide 140 to be described later may be mounted on the inner panel 130. The inner panel 130 may define a space in which air sucked into the door 20 flows together with the air guide 140.

The air guide 140 may be mounted on the inner panel 130, and may be coupled to the frame 160 to provide the space in which air introduced into the door 20 flows.

The air guide 140 may be disposed between the outer panel 120 and the inner panel 130, and may be coupled to the inner panel 130. The air guide 140 may guide the flow of air introduced into the door 20 from the outside and define the space in which air may flow.

The blower 150 may be mounted on the air guide 140. The blower 150 may forcibly allow air introduced into the air guide 140 to flow from a rear side to a front side of the air guide 140.

The shielding portion 23 may include the frame 160 and the choke member 170. The frame 160 may be disposed at the rear of the inner panel 130, may be coupled to the inner panel 130, and may have one side pivotably coupled to the main body 10. The door 20 may pivot as the frame 160 pivots to open and close the cavity 11 of the cooking appliance.

The frame 160 may be coupled to the inner panel 130 to form a flow path of air for cooling, and at the same time, may have a shielding structure for preventing the electromagnetic wave leakage, that is, the choke member 170, to form an inner surface of the door 20.

The choke member 170 may be disposed at the rear of the frame 160, may be coupled to the frame 160, and may block external emission of the electromagnetic wave generated from the main body 10. The choke member 170 may be formed in a substantially hollow quadrangular shape and may surround edges of the frame 160.

FIG. 12 is a perspective view illustrating the outer panel 120 according to an embodiment. FIG. 13 is a view of FIG. 12 in another direction. FIG. 14 is a view illustrating an inner panel and an air guide according to an embodiment. FIG. 15 is an exploded perspective view of FIG. 14.

Referring to FIG. 13, the door 20 may include the speaker 260 and the microphone module 270. At least one speaker 260 may be mounted at a side of the outer panel 120. The speaker 260 may generate a voice, an alarm sound, and the like necessary for the operation of the cooking appliance. In addition, the speaker 260 may generate a voice, an alarm sound, and the like for the door 20 including the display 110 to function as the IoT hub.

The microphone module 270 may be mounted at a lower portion of the outer panel 120 and may include a microphone 271 that receives a user's voice. The user may input a voice command for manipulating the cooking appliance via the microphone module 270. In addition, the microphone module 270 may play a part of a role for the door 20 to function as the IoT hub.

In one example, a communication unit for communication may be disposed in the door. Because the door 20 functions as the IoT hub, it is appropriate that the communication unit disposed in the door 20 is equipped to perform various types of wired or wireless communication functions.

The outer panel 120 may include a first through-hole 120c and a second through-hole 120d. The first through-hole 120c may be defined at the side of the outer panel 120. The first through-hole 120c may be defined adjacent to a location where the speaker 260 is disposed. The first through-hole 120c may be formed in a mesh shape to allow the speaker 260 to be in communication with the outside and simultaneously to suppress the speaker 260 from being exposed to the outside.

The speaker 260 may be in communication with the outside of the outer panel 120 via the first through-hole 120c, thereby effectively transmitting the alarm and other voices to the user. Because the speaker 260 includes a pair of speakers, the first through-hole 120c may also include a pair of first through-holes defined at locations corresponding to the pair of speakers 260, respectively.

The second through-hole 120d may be defined to extend through the outer panel 120 at a lower portion of one side of the outer panel 120. A portion of the button device 300 mounted inside the outer panel 120 may be exposed to the outside of the outer panel 120 via the second through-hole 120d. The user may manipulate the button device 300 by being in contact with an exposed portion of the outer panel 120.

The outer panel 120 may have the first outlet 123 defined at an upper portion thereof and the second outlet 124 defined at a lower portion thereof. The first outlet 123 may be defined at the upper portion of the outer panel 120, and air flowing inside the door may be discharged to the outside by the blower 150. The second outlet 124 may be defined at the lower portion of the outer panel 120, and air flowing inside the door may be discharged to the outside by the blower 150.

The first outlet 123 may be defined at a location adjacent to an upper end of the display 110, and the second outlet 124 may be defined at a location adjacent to a lower end of the display 110. Accordingly, air forced to flow inside the door 20 by the blower 150 may be discharged to the outside at the locations adjacent to the upper end and the lower end of the display 110 via the first outlet 123 and the second outlet 124.

Air discharged via the first outlet 123 may form the air curtain above the door 20. In addition, air discharged via the second outlet 124 may form the air curtain below the door 20.

The air curtain refers to a means for blocking external air flow from penetrating into the door 20. In an embodiment, a boundary surface or a boundary area where the flow of air discharged from the inside of the door 20 via the first outlet 123 and the second outlet 124 forms a boundary with the external air flow may be referred to as the air curtain.

The air curtains formed by air discharged from the inside of the door 20 via the first outlet 123 and the second outlet 124 may suppress external air from penetrating into the door 20.

Because the heating cooking appliance is disposed below the cooking appliance, heat generated when the heating cooking appliance is used and oil vapor generated from the food being cooked may rise and penetrate the cooking appliance.

Heat transferred from the heating cooking apparatus to the cooking apparatus may damage a component of the door 20 disposed in the cooking apparatus. In particular, the display 110 and a component in which a circuit, a module, or the like related to the operation thereof is embedded may be vulnerable to heat.

In addition, oil vapor delivered from the food being cooked may be adhered to the door 20 disposed in the cooking appliance. Oil vapor may be adhered to a surface of the display 110 and degrade an image quality of the display 110, and may be adhered to a surface of other components mounted on the door 20 to damage such components.

In an embodiment, the air flow discharged to the outside of the door 20 via the first outlet 123 and the second outlet 124 defined in the door 20 may form the air curtains, so that heat and oil vapor rising from the heating cooking appliance disposed below the cooking appliance may be effectively blocked by the air curtains.

Accordingly, the various electronic components including the display 110 disposed on the door 20 may be effectively suppressed from being damaged or degraded in function by heat and oil vapor.

Referring to FIG. 14, the air guide 140 may include an inlet 141 and an exhaust port 142. The inlet 141 may be defined at an upper portion of the air guide 140, may allow external air to be introduced thereinto, and may include at least one inlet.

The inlet 141 may be defined at a location corresponding to the first vent hole 121 defined in the upper portion of the outer panel 120. Accordingly, external air may pass through the first vent hole 121 of the outer panel 120 and be introduced into the door 20 via the inlet 141.

The exhaust port 142 may be formed below the inlet 141 in the air guide 140, and the blower fan 152 may be disposed at a location overlapping the exhaust port 142 in the front and rear direction. The exhaust port 142 may be formed to extend through the air guide 140 in the front and rear direction of the door 20.

Accordingly, air may flow from the upper portion to a lower portion of the air guide 140 via the inlet 141, and may flow again via the exhaust port 142 in a changed direction from a rear space to a front space of the air guide 140.

The blower 150 may include a casing 151 and the blower fan 152. The casing 151 may be disposed in the exhaust port 142, may have a hollow defined therein, and may have the blower fan 152 mounted in the hollow.

The blower fan 152 may be rotatably mounted on the casing 151, and may allow air to flow from the rear space to the front space of the air guide 140. The blower fan 152 may rotate by receiving electricity to allow air to flow inside the door 20.

By the rotation of the blower fan 152, external air may be introduced into the door 20 via the inlet 141 and discharged to the outside of the door 20 via the first outlet 123 and the second outlet 124. The exhaust port 142 of the air guide 140 may be formed at a center of the casing 151 to correspond to a location, an area size, and a shape of the hollow in which the blower fan 152 is disposed.

FIG. 16 is a side cross-sectional view of the door 20 viewed in a direction 16-16 in FIG. 5. Hereinafter, the flow of air inside the door 20 will be described in detail with reference to FIG. 16. In FIG. 16, the flow of air is indicated by arrows.

As the blower fan 152 rotates, external air may flow into the door 20 via the inlet 141 of the air guide 140 and may flow to be discharged to the outside of the door 20 via the first outlet 123 and the second outlet 124.

Air forced to flow by the blower fan 152 may specifically have a flow path as follows.

Air may be introduced into the door 20 from the first vent hole 121 of the outer panel 120 and the inlet 141 defined at a location corresponding thereto. Air introduced into the door 20 may flow in a downward direction of the door 20 and may be introduced into the blower fan 152.

Air may pass through the blower fan 152 in the front and rear direction of the door 20. In this regard, air may pass through the exhaust port 142 of the air guide 140 while passing through the blower fan 152. The flow direction of air in the blower fan 152 may be changed from the vertical direction of the door 20 to the front and rear direction.

Because a front space of the exhaust port 142 is blocked by the display 110, air that has passed through the exhaust port 142 may be branched in the vertical direction in a space ahead of the air guide 140.

A portion of the branched air may flow in the upward direction of the door 20 and may be discharged to the first outlet 123. The other portion of the branched air may flow in the downward direction of the door 20 and be discharged to the second outlet 124.

Air branched from the first outlet 123 and the second outlet 124 may surround the entire door 20. The branched air may particularly surround the front surface of the door 20. Because of such a structure, air discharged from the first outlet 123 and the second outlet 124 forms the air curtains on the door 20, thereby effectively suppressing heat and oil vapor generated from the heating cooking appliance disposed below the cooking appliance from penetrating into the door 20.

In addition, because of the above-described air flow structure inside the door 20, air introduced into the door 20 may flow through the entire inside of the door 20. For example, air may flow in an entire space defined by the rear surface of the display 110 and the outer panel 120.

Accordingly, air flowing inside the door 20 may cool the entire rear surface of the display 110 and effectively cool the components mounted on the outer panel 120 and other portions of the door 20.

In particular, the outer panel 120 may be equipped with components that generate heat, such as the speaker 260, the microphone 271, and the printed circuit board. Such heating components may be arranged over the entire outer panel 120. Therefore, air may effectively cool such heating components while flowing through the entire inside of the outer panel 120.

As shown in FIG. 16, the first vent hole 121 through which air is introduced and the inlet 141 may be in communication with each other. As the blower fan 152 rotates, external air may be introduced into the air guide 140 via the first vent hole 121 and the inlet 141 and flow toward the blower 150 via a space defined by the inner panel 130 and the air guide 140.

Air may flow toward the blower fan 152 of the blower 150 in a space defined by the frame 160. Air may pass through the blower fan 152 and hit the rear surface of the display 110 disposed to face the blower fan 152 to cool the display 110.

Air that has passed through the blower fan 152 may hit the rear surface of the display 110, and then the flow thereof may be branched in the upward and downward directions of the display 110. Air directed to an upper side of the display 110 may be discharged to the outside of the door 20 via the first outlet 123 defined at the upper side of the outer panel 120. Air directed to the lower side of the display 110 may be discharged to the outside of the door 20 via the second outlet 124 defined at the lower side of the outer panel 120.

In an embodiment, air flowing inside the door 20 may cool the entire front surface of the display 110 while being discharged via the first outlet 123. In addition, air flowing inside the door 20 may effectively cool the rear surface of the display 110 and the heating components mounted inside the door 20.

The exhaust port 142 may be formed at a center of the air guide 140. The casing 151 may have the hollow having a location, a size, and a shape corresponding to those of the exhaust port 142, and the blower fan 152 may be disposed in the hollow. The casing 151 may be disposed to be located at a location where the hollow thereof and the exhaust port 142 of the air guide 140 correspond to each other, and may be mounted on one surface of the air guide 140.

A hollow 130a may be defined in the inner panel 130. Because the hollow 130a of the inner panel 130 is closed by the frame 160, air introduced via the inlet 141 may not leak into the hollow 130a of the inner panel 130. Accordingly, the inner panel 130 and the frame 160 may form together an air flow path through which air that cools the inside of the door 20 flows.

FIG. 17 is an enlarged view of a portion 17 in FIG. 16. The door 20 may include a front coupling portion 24 disposed upward of the display 110, protruding forwardly of the door 20, and coupled to the outer panel 120. A gap having a predetermined size may be formed between a lower portion of the front coupling portion 24 and the front surface of the display 110, and such a gap may serve as a discharge path for air that cools the inside of the door 20.

The front coupling portion 24 may include a sensing module 310 and a panel 320. The sensing module 310 may be disposed upward and forward of the display module 21, may sense an external situation, and may include various types of sensing devices.

The panel 320 may be disposed upward and forward of the display module 21. The panel 320 may cover the sensing module 310. Because the panel 320 covers the sensing module 310, the panel 320 may form an outer shape of the front coupling portion 24. In this regard, the sensing module 310 may be accommodated in the panel 320.

In another embodiment, the sensing module 310 may not be accommodated in the panel 320, but may be disposed at the rear of the panel 320.

The panel 320 may be disposed to overlap the display module 21. In another embodiment, the panel 320 may be disposed above the display module 21 without overlapping the display module 21.

The panel 320 may protrude forward of the display module 21. In another embodiment, the panel 320 may not protrude with respect to the display module 21, and may be disposed such that a front surface thereof is on the same plane as a front surface of the display module 21 or lies rearward of the front surface of the display module 21.

The panel 320 may be disposed such that a longitudinal direction thereof is directed in the lateral direction of the door 20, and may be formed in an overall long rod shape. The panel 320 may guide the flow direction of air discharged from the first outlet 123. For example, the panel 320 may change the flow direction of air discharged from the first outlet 123 to the downward direction.

To this end, the panel 320 may be disposed in front of the first outlet 123. The panel 320 may be disposed to overlap the first outlet 123 in the front and rear direction. Air flowing inside the door 20 may be discharged in the forward direction of the door 20 via the first outlet 123 located at the upper portion of the door 20.

In this regard, the panel 320 may block the first outlet 123 from the front, and air discharged from the first outlet may be blocked by the panel 320 and the flow direction thereof may be changed from the forward direction to the downward direction of the door 20.

In addition, a lower end of the panel 320 may protrude further downward than a lower end of the first outlet 123. Because of such a structure, air discharged from the first outlet 123 may collide with the panel 320 and may be guided by the panel 320, so that the flow path thereof may be changed to the downward direction.

Air discharged from the first outlet 123 in the forward direction may flow in the downward direction by the panel 320.

Air discharged in the forward direction from the first outlet 123 may collide with a rear surface of the panel 320 and flow in a changed direction toward an open lower portion between the panel 320 and the first outlet 123. In addition, because the lower end of the panel 320 further protrudes in the downward direction than the lower end of the first outlet 123, air may be guided by the lower end of the panel 320 to flow, and then may continue to flow in the downward direction of the door 20 for a certain period of time after exiting the door 20.

Air forced to flow by the blower fan 152 may be introduced from the inlet 141, flow in the downward direction of the door 20, be introduced into the blower fan 152, pass the blower fan 152 in the front and rear direction of the door 20, and diverge in the vertical direction at a location in front of the air guide 140. Further, a portion of air may flow in the upward direction of the door 20 and be discharged to the first outlet 123, and the rest of air may flow in the downward direction of the door 20 and be discharged to the second outlet 124.

In this regard, air discharged from the first outlet 123 may be guided by the panel 320 to flow downward, and at least a portion thereof may comes into contact with the front surface of the display 110. In addition, at least a portion of air discharged from the second outlet 124 may flow forward of the door 20.

Air discharged from the second outlet 124 may flow forward of the door 20, and thus may serve as the air curtain that blocks oil vapor and other foreign substances rising from the heating cooking appliance below the cooking appliance from being adhered to the front surface of the display 110.

Air discharged from the first outlet 123 may form the air curtain like air discharged from the second outlet 124 to prevent oil vapor or the like from being adhered to the front surface of the display 110.

In addition, air discharged from the first outlet 123 may be changed in the flow direction by the panel 320 and discharged in the downward direction of the door 20, so that at least a portion thereof may come into contact with the front surface of the display 110.

Because of such a structure, air discharged from the first outlet 123 may directly come into contact with the front surface of the display 110 to cool the front surface of the display 110. Therefore, the front surface and the rear surface of the display 110 are both cooled by air, so that cooling efficiency may be significantly improved compared to a case in which only the rear surface of the display 110 is cooled.

FIG. 18 is a perspective view in which some parts of the microphone module 270 according to an embodiment are removed from the door 20. The microphone module 270 is a device including the microphone 271 that recognizes the user's voice. Such a microphone module 270 needs to be disposed at a location where the user's voice is easily incident on the microphone 271.

Because the user performs the cooking in front of the cooking appliance, it may be appropriate to place the microphone module 270 on the door 20 located at the front portion of the cooking appliance.

In addition, the cooking appliance may be disposed above the heating cooking apparatus and may have a somewhat large volume. For this reason, when the microphone module 270 is disposed at a lower portion of the door 20, a distance between the microphone module 270 and the user may be significantly reduced.

Specifically, the microphone module 270 may be disposed at a lower side of the outer panel 120 forming the overall outer appearance of the door 20, and accordingly, the distance between the user and the microphone module 270 may be reduced, so that the microphone 271 may accurately recognize the user's voice.

In one example, when the microphone module 270 is disposed on the outer panel 120, the foreign substances such as oil vapor rising from the heating cooking apparatus located below the cooking appliance are adhered to the microphone 271, so that the microphone 271 may fail or may deteriorate in performance. Therefore, an action therefor is needed.

A distribution ratio of the foreign substances rising from the heating cooking appliance may be the highest at a central portion of a bottom surface of the cooking appliance. Accordingly, a large amount of foreign substances may be adhered to the central portion of the bottom surface of the outer panel 120.

Therefore, to reduce the adhesion of the foreign substances to the microphone module 270, there is a need to dispose the microphone module 270 at a location deviated from the central portion of the bottom surface of the outer panel 120, that is, a bottom plate 126.

Therefore, in an embodiment, the microphone module 270 may be disposed at the lower portion of the outer panel 120. The microphone module 270 may be disposed at an edge spaced apart from the center of the outer panel 120 in the lateral direction.

By disposing the microphone module 270 at such a location, a large portion of the foreign substances generated and rising from the heating cooker disposed below the cooking appliance may be adhered to the central portion of the bottom surface of the outer panel 120, and a relatively small amount of the foreign substances may reach the microphone module 270 disposed at the edge of the outer panel 120. Therefore, an amount of foreign substances introduced into the microphone module 270 is reduced, so that the failure and the performance degradation of the microphone module 270 may be effectively suppressed. Hereinafter, the microphone module 270 will be described in more detail with reference to the drawings.

FIG. 19 is a perspective view of the microphone module 270 according to an embodiment. FIG. 20 is a view of FIG. 19 in another direction. FIG. 21 is an exploded perspective view of the microphone module 270 according to an embodiment. FIG. 22 is a view of FIG. 21 in another direction.

The microphone module 270 may include at least one of the microphone 271, a mounting substrate 272, a low supporter 273, and an upper supporter 274.

The microphone 271 may receive the user's voice. The microphone 271 may be mounted on a rear surface of the mounting substrate 272. A hole may be defined at a location corresponding to the microphone 271 in the mounting substrate 272, the supporter layer 276, and the low supporter 273 disposed in front of the microphone 271. Accordingly, because the microphone 271 may recognize the user's voice introduced through such holes, sensitivity of the voice recognition may be improved.

FIG. 23 is a front view of the mounting substrate 272 according to an embodiment. FIG. 24 is a rear view of the mounting substrate 272 according to an embodiment.

The microphone 271 may be mounted on the mounting substrate 272. In an embodiment, to increase the voice recognition sensitivity, the microphone 271 may include a plurality, for example, a pair of microphones, spaced apart from each other. Accordingly, the pair of microphones 271 may be mounted on the rear surface of the mounting substrate 272 while being spaced apart from each other in a longitudinal direction of the mounting substrate 272.

The mounting substrate 272 may be equipped with a circuit and various elements necessary for the operation of the microphone 271. In addition, a connection socket 2721 for electrical connection of the microphone 271 and a device for controlling the microphone 271 and/or a power supply device may be mounted on the rear surface of the mounting substrate 272.

In addition, a voice input hole 2722 may be defined in the mounting substrate 272 to extend through the mounting substrate 272 at the location where the microphone 271 is disposed, and provide a path through which external voice is input to the microphone 271.

Accordingly, even when the microphone 271 is disposed on the rear surface of the mounting substrate 272, the user's voice may be clearly recognized via the voice input hole 2722.

The microphone 271 or the mounting substrate 272 may be disposed in the low supporter 273. The low supporter 273 may define a space in which the microphone 271 and the mounting substrate 272 are accommodated.

The upper supporter 274 may support one surface of the mounting substrate 272, and may accommodate a portion of the microphone 271 or the mounting substrate 272 together with the low supporter 273. Accordingly, the microphone 271 or the mounting substrate 272 may be accommodated in a space defined inside an assembly of the low supporter 273 and the upper supporter 274 and may be protected by such an assembly.

FIG. 25 is a perspective view of the upper supporter 274 according to an embodiment. FIG. 26 is a front view of the upper supporter 274 according to an embodiment. The upper supporter 274 may include at least one of a space defining groove 2741 or a rib mounting groove 2742.

The space defining groove 2741 may be defined by recessing an outer surface of a portion of the upper supporter 274 where the microphone 271 is disposed. The microphone 271 may be accommodated in the space defining groove 2741. In an embodiment, because the microphone 271 includes the pair of microphones, the space defining groove 2741 may also include a pair of space defining grooves.

The space defining groove 2741 may be defined in a front surface of the upper supporter 274. In this regard, because the mounting substrate 272 is defined to be inclined in the front surface of the upper supporter 274, the front surface of the upper supporter 274 may also be formed to be inclined corresponding thereto.

The rib mounting groove 2742 may be defined by recessing a bottom surface of the upper supporter 274 in the upward direction. Accordingly, the rib mounting groove 2742 may be defined to be convex upward with respect to the upper supporter 274.

A first coupling rib 2732 of the low supporter 273 may be fitted into the rib mounting groove 2742. In a state in which the first coupling rib 2732 is fitted into the rib mounting groove 2742, a coupling mechanism such as a screw or the like is fastened thereto, so that the low supporter 273 and the upper supporter 274 may be coupled to each other. For such fastening, a third fastening hole 2742a into which the coupling mechanism is inserted may be defined in the rib mounting groove 2742 of the upper supporter 274.

A sticker 2743 for adhering the mounting substrate 272 to the upper supporter 274 may be adhered to the front surface of the upper supporter 274. The sticker 2743 may be of a double-sided adhesive type to adhere the mounting substrate 272 to the upper supporter 274. The sticker 2743 may allow the mounting substrate 272 to be stably fixed to the upper supporter 274 by bonding the mounting substrate 272 and the upper supporter 274 to each other.

FIG. 27 is a plan view of the low supporter 273 according to an embodiment. FIG. 28 is a front view of the low supporter 273 according to an embodiment. FIG. 29 is a side view of the low supporter 273 according to an embodiment. The low supporter 273 may include at least one of a protrusion accommodating portion 2731, a first coupling rib 2732, and a second coupling rib 2733.

The protrusion accommodating portion 2731 may have a bottom surface protruding downward, and a top surface thereof may define a space for accommodating the mounting substrate 272 and the microphone 271. The protrusion accommodating portion 2731 may be formed to protrude such that a bottom surface of the low supporter 273 is downwardly convex.

The first coupling rib 2732 may protrude upward from a bottom surface of the protrusion accommodating portion 2731, may be coupled to the upper supporter 274, and may have a first fastening hole 2732a to which the coupling mechanism is fastened.

The first coupling rib 2732 may be fitted into the rib mounting groove 2742 of the upper supporter 274, and the coupling mechanism may be fastened to the first coupling hole 2732a of the first coupling rib 2732 and the third fastening hole of the rib mounting groove 2742, so that the low supporter 273 and the upper supporter 274 may be coupled to each other. The first coupling rib 2732 may include a pair of first coupling ribs spaced apart from each other, and the rib mounting groove 2742 may also include a pair of rib mounting grooves spaced apart from each other corresponding thereto.

The second coupling rib 2733 may protrude upward from an edge of the protrusion accommodating portion 2731, may be coupled to the outer panel 120, and may have a second fastening hole 2733a to which the coupling mechanism is fastened. The second coupling rib 2733 may be fastened to the outer panel 120 by the coupling mechanism. Accordingly, the microphone module 270 of an embodiment may be stably fixed to the outer panel 120.

The second coupling rib 2733 may be coupled to a first coupling protrusion 1271 of the outer panel 120. The second coupling rib 2733 may include a pair of second coupling ribs spaced apart from each other, and the first coupling protrusion 1271 may also include a pair of first coupling protrusions spaced apart from each other corresponding thereto.

In one example, the microphone module 270 may include an adhesive layer 275 that is disposed between the mounting substrate 272 and the low supporter 273 and bonds the mounting substrate 272 to the rear surface of the low supporter 273.

The adhesive layer 275 may be of the double-sided adhesive type, and may have one surface adhered to a rear surface of the inclined surface of the low supporter 273 and the other surface adhered to a front surface of the mounting substrate 272. The adhesive layer 275 may bond the mounting substrate 272 and the low supporter 273 to each other, so that the mounting substrate 272 may be stably fixed to the low supporter 273.

Although it is not an essential component, in an additional embodiment, a supporter layer 276 may be disposed between the adhesive layer 275 and the mounting substrate 272. The supporter layer 276 may also be of the double-sided adhesive type, so that both surfaces thereof may be adhered to the adhesive layer 275 and the mounting substrate 272, respectively.

The supporter layer 276 may supplement a thickness of the adhesive layer 275 to fill a gap between the rear surface of the low supporter 273 and the front surface of the mounting substrate 272, so that the mounting substrate 272 may be stably adhered to the low supporter 273.

The supporter layer 276 may include one supporter layer, but may include a plurality of supporter layers as necessary. For example, as illustrated in FIGS. 20 and 21, the supporter layer 276 may be composed of a first layer 2761 having one surface adhered to the mounting substrate 272 and a second layer 2762 having one surface adhered to the low supporter 273. However, the present disclosure may not be limited thereto, and the supporter layer 276 may include three or more supporter layers 276 such that an adhesive portion has a required thickness.

Holes may be defined in the adhesive layer 275 and the supporter layer 276 at locations corresponding to the voice input hole 2722 of the mounting substrate 272 and the microphone 271. Accordingly, a space in front of the microphone 271 is opened, so that the user's voice may be clearly input to the microphone 271.

Referring to FIG. 17, the outer panel 120 may include the bottom plate 126. An insertion hole 1261 into which the low supporter 273 is inserted may be defined in the bottom plate 126. The low supporter 273 may be formed in a rectangular shape as a whole in a plan view. The insertion hole 1261 may also be formed in a rectangular shape corresponding thereto.

The mounting substrate 272 may be formed in a rectangular shape and may have a sufficient area size for the plurality of microphones 271 to be mounted. The low supporter 273 where the mounting substrate 272 is accommodated and the microphone module 270 may also be formed in a rectangular shape corresponding thereto.

The insertion hole 1261 may be defined at an edge of the bottom plate 126 such that a longitudinal direction thereof is parallel to the lateral direction of the outer panel 120. Because the bottom plate 126 is formed to have a narrow width in the front and rear direction and to be elongated in the lateral direction, the rectangular insertion hole 1261 into which the rectangular low supporter 273 is inserted may also be disposed such that the longitudinal direction thereof is parallel to the lateral direction of the outer panel 120.

Because of such a structure, a space in which the microphone module 270 may be mounted may be sufficiently secured in the bottom plate 126 of the outer panel 120.

FIG. 30 is a view illustrating the first coupling protrusion 1271 disposed on the outer panel 120. The outer panel 120 may include a front plate 127 that is bent from the bottom plate 126 and on which the display 110 is disposed.

The front plate 127 may include the first coupling protrusion 1271 protruding from a rear surface thereof and coupled with the second coupling rib 2733. The first coupling protrusion 1271 may include a number of first coupling protrusions corresponding to the number of second coupling ribs 2733, positioned on the front plate 127 at locations corresponding to the second coupling ribs 2733. In an embodiment, because the second coupling rib 2733 includes the pair of second coupling ribs spaced apart from each other, the first coupling protrusion 1271 may also include a pair of first coupling protrusions spaced apart from each other.

The first coupling protrusion 1271 may have a hole, to which the coupling mechanism is fastened, defined at a center thereof so as to correspond to the second coupling hole 2733a of the second coupling rib 2733. When the first coupling protrusion 1271 and the second coupling rib 2733 are fastened to each other by the coupling mechanism such as the screw or the like, the microphone module 270 including the low supporter 273 may be firmly coupled to the outer panel 120.

Hereinafter, a detailed structure of the low supporter 273 will be described with reference to the drawings.

The low supporter 273 may include a catching portion 2734 that protrudes laterally from an edge of the protrusion accommodation portion 2731, is disposed to overlap a portion of the bottom plate 126 forming an edge of the insertion hole 1261, and supports the low supporter 273.

The catching portion 2734 may protrude laterally from an inclined surface of the low supporter 273 and may have a rectangular outer shape. The catching portion 2734 may be caught on a top surface of the bottom plate 126 adjacent to the edge of the insertion hole 1261 to allow the entire microphone module 270 to be supported by the bottom plate 126 and serve as a stopper for preventing the lower supporter 273 from descending any more.

The protrusion accommodation portion 2731 may include an inclined portion 2731a and an exposure hole 2731b. The inclined portion 2731a may allow the microphone 271 to be disposed to be inclined at a predetermined angle with respect to the vertical direction. The inclined portion 2731a may be formed to be inclined with respect to the vertical direction and the front and rear direction, and the mounting substrate 272 on which the microphone 271 is mounted may be attached to a rear surface of the inclined portion 2731a.

Accordingly, the microphone 271 may be disposed to be inclined such that a front surface thereof faces both forward and downward of the door 20. Because the microphone 271 is disposed to be inclined as such, the microphone 271 may clearly sense the user's voice uttered at the location in front of and downward of the door 20, and thus may sense the user's voice in a wide range.

The exposure hole 2731b may be defined to extend through the inclined portion 2731a, and may expose a portion of an inside of the microphone module 270 to the outside. The exposure hole 2731b may be defined in a portion corresponding to the voice input hole 2722 and the microphone 271 to open the space in front of the microphone 271, thereby increasing accuracy of the voice recognition of the microphone 271.

In one example, because the microphone module 270 is disposed at the lower portion of the door 20, the foreign substances such as oil vapor may rise from the heating cooking appliance located below the door 20 and reach the microphone module 270. Such foreign substances may reach the inside of the microphone module 270 via the exposure hole 2731b and may be adhered to the mounting substrate 272 and the microphone to damage them.

In addition, because of continuous and repeated use of the heating cooking apparatus located below the cooking appliance, such foreign substances may be accumulated in the exposure hole 2731b and block the exposure hole 2731b, and accordingly, the voice recognition of the microphone 271 may be hindered and the accuracy of the voice recognition may be lowered. Therefore, it is necessary to suppress the foreign substances in the rising vapor state from approaching the exposure hole 2731b.

To this end, the microphone module 270 in an embodiment may include a suppression protrusion that suppresses the foreign substances from approaching the exposure hole 2731b. Specifically, the low supporter 273 may include a first suppression protrusion 2735 and a second suppression protrusion 2736.

The first suppression protrusion 2735 may be formed at a location corresponding to the exposure hole 2731b, and may be formed to extend further at a lower portion thereof than at an upper portion thereof, thereby suppressing the foreign substances in the vapor state from flowing into the exposure hole 2731b.

The first suppression protrusion 2735 may be formed such that a portion of the exposure hole 2731b is defined and a lower portion of the exposure hole 2731b is surrounded, and may have a protruding length increasing from the upper portion toward the lower portion thereof.

Accordingly, a front surface of the first suppression protrusion 2735 may be directed in a direction orthogonal to the front and rear direction of the low supporter 273. In addition, the exposure hole 2731b may be defined through the first suppression protrusion 2735.

The second suppression protrusion 2736 may protrude downward from an upper end of the inclined portion 2731a, and may suppress the foreign substances in the vapor state from entering the exposure hole 2731b. The second suppression protrusion 2736 may be disposed such that a longitudinal direction thereof is parallel to a longitudinal direction of the low supporter 273, and may be formed such that a front surface thereof is directed in a direction parallel to the vertical direction.

Because of such a structure, the second suppression protrusion 2736 may effectively suppress the foreign substances flowing rearward from the space in front of the door 20 and directed to the low supporter 273 from approaching the exposure hole 2731b.

FIG. 31 is a cross-sectional view of the microphone module 270, in which the microphone 271 is cut. In FIG. 31, the flow of the foreign substances in the vapor state from the outside of the door 20 toward the microphone module 270 is illustrated by an arrow.

First, the foreign substances generated from the heating cooking appliance located below the cooking appliance and raised to approach the door 20 may collide with the bottom surface of the low supporter 273 and flow along the same to approach the exposure hole 2731b.

In this regard, the foreign substances approaching the exposure hole 2731b may be blocked by the first suppression protrusion 2735 and effectively suppressed from being introduced into the exposure hole 2731b.

Next, the foreign substances in the vapor state flowing rearward from the space in front of the cooking appliance and approaching the low supporter 273 may be blocked by the second suppression protrusion 2736 disposed in front of the exposure hole 2731b and effectively suppressed from being introduced into the exposure hole 2731b.

The first suppression protrusion 2735 and the second suppression protrusion 2736 do not block all of the foreign substances in the vapor state flowing around the low supporter 273 from being introduced into the exposure hole 2731b, but because of the presence of the first suppression protrusion 2735 and the second suppression protrusion 2736, the introduction of a significant amount of foreign substances into the exposure hole 2731b may be effectively blocked.

In an embodiment, the first suppression protrusion 2735 and the second suppression protrusion 2736 disposed on the low supporter 273 may effectively block the foreign substances from being introduced into the exposure hole 2731b. Accordingly, the foreign substances may be suppressed from being introduced into the exposure hole 2731b, and thus the electrical components such as the microphone and the mounting substrate 272 inside the microphone module 270 may be effectively protected.

In addition, accordingly, clogging of the exposure hole 2731b by the foreign substances may be effectively suppressed, thereby effectively suppressing a deterioration of a voice recognition performance of the microphone 271.

Although the present disclosure has been described with reference to the accompanying drawings, the present disclosure is not limited by the embodiments disclosed herein and the drawings, and it is obvious that various modifications may be made by those skilled in the art within the scope of the technical idea of the present disclosure. In addition, although the effects based on the configuration of the present disclosure are not explicitly described and illustrated in the description of the embodiment of the present disclosure above, it is natural that predictable effects of the corresponding configuration should also be recognized.

What is claimed is:

1. A cooking appliance comprising a main body with a cavity defined therein, and a door configured to open and close the cavity, wherein the door includes:
a display configured to display an image thereon;
an outer panel disposed at the rear of the display, wherein the display is mounted on the outer panel; and
a microphone module disposed at a lower portion of the outer panel and positioned at an edge spaced apart from a center of the outer panel in a lateral direction.

2. The cooking appliance of claim 1, wherein the microphone module includes:
a microphone configured to receive a user's voice;
a mounting substrate where the microphone is mounted;
a low supporter where the microphone and the mounting substrate are disposed; and
an upper supporter constructed to support one surface of the mounting substrate and accommodate portions of the microphone and the mounting substrate together with the low supporter.

3. The cooking appliance of claim 2, wherein the low supporter includes:
a protrusion accommodating portion having a bottom surface protruding downward and a top surface defining a space where the mounting substrate and the microphone are accommodated;
a first coupling rib protruding upward from the bottom surface of the protrusion accommodating portion, coupled with the upper supporter, and having a first fastening hole defined therein, where a coupling mechanism is fastened; and
a second coupling rib protruding upward from an edge of the protrusion accommodating portion, coupled with the outer panel, and having a second fastening hole defined therein, where a coupling mechanism is fastened.

4. The cooking appliance of claim 3, wherein the outer panel includes a bottom plate,
wherein an insertion hole is defined in the bottom plate, and the low supporter is inserted into the insertion hole,
wherein the insertion hole is defined such that a longitudinal direction thereof is parallel to the lateral direction of the outer panel at an edge of the bottom plate.

5. The cooking appliance of claim 4, wherein the outer panel includes a front plate bent from the bottom plate and having the display disposed thereon, and
wherein the front plate includes a first coupling protrusion protruding from a rear surface thereof and coupled with the second coupling rib.

6. The cooking appliance of claim 4, wherein the low supporter includes a catching portion protruding laterally from the edge of the protrusion accommodating portion, disposed to overlap a portion of the bottom plate forming an edge of the insertion hole, and supporting the low supporter.

7. The cooking appliance of claim 3, wherein the protrusion accommodating portion includes:
an inclined portion where the microphone is disposed to be inclined at a predetermined angle with respect to a vertical direction; and
an exposure hole defined to extend through the inclined portion and constructed to expose a portion of an interior of the microphone module to the outside.

8. The cooking appliance of claim 7, wherein the low supporter includes:
a first suppression protrusion formed at a location corresponding to the exposure hole, wherein the first suppression protrusion is formed to extend further at a lower portion than at an upper portion to suppress foreign substances in a vapor state from flowing into the exposure hole; and
a second suppression protrusion protruding downward from an upper end of the inclined portion to suppress the foreign substances in the vapor state from flowing into the exposure hole.

9. The cooking appliance of claim 8, wherein the first suppression protrusion is formed to define a portion of the exposure hole, surround a lower portion of the exposure hole, and have a protruding length increasing in a downward direction.

10. The cooking appliance of claim 8, wherein the second suppression protrusion is disposed such that a longitudinal direction thereof is parallel to a longitudinal direction of the low supporter, and has a front surface directed parallel to the vertical direction.

11. The cooking appliance of claim 2, wherein the microphone module includes an adhesive layer disposed between the mounting substrate and the low supporter and adhering the mounting substrate to a rear surface of the low supporter.

12. A cooking appliance comprising a main body with a cavity defined therein, and a door configured to open and close the cavity, wherein the door includes:
an outer panel forming an outer appearance of the door; and
a microphone module disposed at a lower portion of the outer panel and positioned at an edge spaced apart from a center of the outer panel in a lateral direction, wherein the microphone module includes:
a microphone configured to receive a user's voice;
a mounting substrate where the microphone is mounted;
a low supporter where the microphone and the mounting substrate are disposed; and
an upper supporter constructed to support one surface of the mounting substrate and accommodate portions of the microphone and the mounting substrate together with the low supporter.

13. The cooking appliance of claim 12, wherein the microphone includes a plurality of microphones spaced apart from each other and mounted on a rear surface of the mounting substrate, and
wherein a voice input hole is defined in the mounting substrate to extend therethrough at a location where the microphone is disposed, and provides a path for external voice to be input into the microphone.

14. The cooking appliance of claim 12, wherein the low supporter includes:
a protrusion accommodating portion having a bottom surface protruding downward and a top surface defining a space where the mounting substrate and the microphone are accommodated;
a first coupling rib protruding upward from the bottom surface of the protrusion accommodating portion, coupled with the upper supporter, and having a first fastening hole defined therein, where a coupling mechanism is fastened; and
a second coupling rib protruding upward from an edge of the protrusion accommodating portion, coupled with the outer panel, and having a second fastening hole defined therein, where a coupling mechanism is fastened.

15. The cooking appliance of claim 14, wherein the protrusion accommodating portion includes:
an inclined portion where the microphone is disposed to be inclined at a predetermined angle with respect to a vertical direction; and
an exposure hole defined to extend through the inclined portion and constructed to expose a portion of an interior of the microphone module to the outside.

16. The cooking appliance of claim 15, wherein the low supporter includes:
a first suppression protrusion formed at a location corresponding to the exposure hole, wherein the first suppression protrusion is formed to extend further at a lower portion than at an upper portion to suppress foreign substances in a vapor state from flowing into the exposure hole; and
a second suppression protrusion protruding downward from an upper end of the inclined portion to suppress the foreign substances in the vapor state from flowing into the exposure hole.

17. The cooking appliance of claim 16, wherein the first suppression protrusion is formed to define a portion of the exposure hole, surround a lower portion of the exposure hole, and have a protruding length increasing in a downward direction, and
wherein the second suppression protrusion is disposed such that a longitudinal direction thereof is parallel to a longitudinal direction of the low supporter, and has a front surface directed parallel to the vertical direction.
